(19) United States
(12) Patent Application Publication
(10) Pub. No.: US 2012/0324397 A1
(43) Pub. Date: Dec. 20, 2012

(54) SYSTEM AND METHOD FOR WIRELESS INTERACTION WITH MEDICAL IMAGE DATA

(76) Inventors: Tabb Alan Patz, New Berlin, WI (US); John David Hoford, Pewaukee, WI (US)

(21) Appl. No.: 13/163,998

(22) Filed: Jun. 20, 2011

(51) Int. Cl. G06F 3/048

(52) U.S. Cl. 715/800; 715/764

(57) ABSTRACT

A system and method includes transmission of a request over a wireless network for a first image having a first resolution from a server coupled to a medical image database, display of the first image on a GUI of a personal device, receipt of a command to modify the first image, and transmission of a request over the network to the server to generate a transient image responsive to the command, the transient image having a second resolution lower than the first resolution. The system also includes display of the transient image on the GUI and comparison of an inactive period with a threshold. If the inactive period exceeds the threshold, the system includes transmission of a request over the network to the server to generate a second image and display the second image on the GUI, the second image corresponding to the transient image and having the first resolution.

### BACKGROUND OF THE INVENTION

Embodiments of the invention relate generally to diagnostic imaging and, more particularly, to a system and method for wireless interaction with medical image data.

In the field of medical diagnostic imaging, various processes are currently used for generating images and managing their distribution and use. Imaging modalities may include magnetic resonance imaging (MRI), computed tomography (CT), positron emission tomography (PET), ultrasound, X-ray, and X-ray tomosynthesis, as examples.

In a common scenario, digital information is gathered from an imaging modality, and raw image data is processed to create data that can be reconstructed into useful images. As one example, in computed tomography (CT) imaging systems, an x-ray source emits a fan-shaped beam toward a subject or object, such as a patient or a piece of luggage. Hereinafter, the terms “subject” and “object” shall include anything capable of being imaged. The beam, after being attenuated by the subject, impinges upon an array of radiation detectors. The intensity of the attenuated beam radiation received at the detector array is typically dependent upon the attenuation of the x-ray beam by the subject. Each detector element of the detector array produces a separate electrical signal indicative of the attenuated beam received by each detector element. The electrical signals are transmitted to a data processing system for analysis which ultimately produces an image.

The resulting image data is stored in a large capacity memory device, such as a picture archiving and communications system (PACS). Each image represents a large data set defining discrete picture elements (pixels) of a reconstructed image, or volume elements (voxels) in three dimensional data sets. CT imaging systems, for example, can produce numerous separate images along an anatomy of interest in a very short examination time frame. Other imaging modalities are similarly capable of producing large volumes of useful image data, including MRI systems, X-ray systems, X-ray tomosynthesis systems, ultrasound systems, PET systems, and so forth.

In the medical diagnostic field, image files are typically created during an image acquisition, encoding, or processing (e.g., reconstruction) sequence, such as in an X-ray, MRI, CT, or other system, or in a processing station designed to process image data from such systems. The image data may be subsequently processed or reprocessed, such as to adjust dynamic ranges or to enhance certain features shown in the image for storage, transmittal, and display.

The images can be retrieved from the PACS for pre-processing, for reading by a radiologist for review and diagnosis, and so forth. Pre-processing is often handled by clinicians or technicians who access the data at a workstation. The images are then re-accessed by the radiologist who can more carefully examine the pre-processed images for normal and diseased tissues, progress or response to treatments, and so forth.

While image files may be stored in raw and processed formats, many image files are quite large and occupy considerable disc or storage space. Moreover, an almost exponential increase in the resolution of imaging systems has occurred in recent years, leading to the creation of even larger image files.

In addition to occupying large segments of available memory, large image files can be difficult or time consuming to transmit from one location to another. As an example, a physician desiring to access an image data file over a wireless network using a handheld computer or other personal wireless device may experience unacceptably long download times while waiting for the image to download and refresh on the device.

Current image handling techniques include compression of image data within the PACS environment to reduce the storage requirements and transmission times. For example, high resolution image data may initially be compressed to a high compression ratio having a compression ratio of 1, for example, for transmission and later decompressed to a higher image quality having a compression ratio of 9, for example. Such compression techniques generally, however, do not offer sufficiently rapid compression and decompression of image files to satisfy increasing demands on system throughput rates and access times. Further, such techniques do not facilitate rapid transmission of image data and real time updates to a personal device over a wireless network responsive to user interaction with the image on the personal device.

Therefore, it would be desirable to design a system and method which permits a user to access image data files over a wireless connection, manipulate the image view in real time, and view real time changes in the image view on a wireless device without lengthy wait times for image transmission.

### BRIEF DESCRIPTION

Embodiments of the invention are directed to a system and method for wireless interaction with medical image data.

According to an aspect of the invention, a non-transitory computer readable storage medium has stored thereon a computer program comprising instructions which, when executed by a computer, cause the computer to transmit a request over a wireless network for a first medical image from a server coupled to a medical image database, the first medical image having a first image resolution. The instructions also cause the computer to display the first medical image on a graphical user interface (GUI) of a wireless personal device, receive a user-selected command to modify the first medical image, and transmit a request over the wireless network to the server to generate a transient image responsive to the command to modify. The transient image has a second image resolution that is lower than the first image resolution. Further, the instructions cause the computer to display the transient image on the GUI and compare a period of user inactivity with a threshold. If the period of user inactivity is greater than the threshold, the instructions cause the computer to transmit a request over the wireless network to the server to generate a second medical image from the server, the second medical image corresponding to the transient image and having the first image resolution and display the second medical image on the GUI.

According to another aspect of the invention, a method of transmitting medical image data includes accessing image data obtained by a medical imaging system via a server coupled to the medical imaging system, transmitting a first static image from the server via a wireless network to a personal device, and displaying the first static image on the personal device. The method also includes receiving a command on the server from the personal device to update the first static image based on a user input and transmitting a transient image from the server to the personal device via the wireless network responsive to the command, the transient image having an image resolution lower than an image resolution of the first static image. Further, the method includes displaying the transient image on the personal device, identifying a period of user inactivity on the personal device, and transmitting a second static image from the server to the personal device via the wireless network following the period of user inactivity. The second static image corresponds to the transient image and has an image resolution greater than the image resolution of the transient image. Still further, the method includes displaying the second static image on the personal device.

According to yet another aspect of the invention, an imaging system includes a remote device coupled to a server via a wireless network. The remote device is configured to communicate with the server to request and receive images over the wireless network. The imaging system also includes a processor that is programmed to request a first image from the server via the wireless network, the first image having a first image resolution, display the first image on a GUI of the remote device, and receive an image manipulation command from a user. The processor is also programmed to request an updated image from the server via the wireless network based on the image manipulation command and display the updated image on the GUI, the updated image having a second image resolution that is lower than the first image resolution. Further, if a predetermined time period has elapsed following receipt of the image manipulation command, the processor is programmed to request a high resolution updated image from the server corresponding to the updated image, the high resolution updated image having the first image resolution, and display the high resolution updated image on the GUI.

Various other features and advantages will be made apparent from the following detailed description and the drawings.

### BRIEF DESCRIPTION OF THE DRAWINGS

The drawings illustrate preferred embodiments presently contemplated for carrying out the invention.

In the drawings:

FIG. 1 is a pictorial view of a CT imaging system.

FIG. 2 is a block schematic diagram of the system illustrated in FIG. 1.

FIG. 3 is a block schematic diagram of an image processing and analysis system, in accordance with an embodiment of the present invention.

FIG. 4 is a flowchart illustrating a technique for accessing, viewing, and interacting with medical image data, in accordance with an embodiment of the present invention.

FIG. 5 is a plan view of a personal device illustrating an exemplary visual representation of a GUI for displaying images, in accordance with an embodiment of the present invention.

FIG. 6 is a pictorial view of a CT system for use with a non-invasive package inspection system.

### DETAILED DESCRIPTION

In the medical field, many different sources producing different types of medical images are available for diagnosing and treating patient conditions. X-ray radiography, computer tomography (CT), magnetic resonance imaging (MRI), ultrasound, positron emission tomography (PET), and so forth, may be used to produce images that may be used in the diagnostic process. The images may be stored in electronic databases and may be accessed by remote clients, thus allowing medical personnel to access image data remotely to display and manipulate (e.g., zoom, rotate, pan, pause) the images.

Embodiments of the invention are described herein as they may be applied in conjunction with an exemplary imaging system, in this case a computed tomography (CT) imaging system. In general, however, the techniques described herein are equally applicable with image data produced by any suitable imaging modality. In a typical application, the imaging system may be designed both to acquire original image data and to process the image data for display and analysis is presented. As noted below, however, in certain applications the image data acquisition and subsequent processing may be carried out in physically separate systems or work stations.

The operating environment of embodiments of the invention is described with respect to a sixty-four-slice computed tomography (CT) system. However, it will be appreciated by those skilled in the art that the invention is equally applicable for use with other multi-slice configurations. Moreover, the invention will be described with respect to the detection and conversion of x-rays. However, one skilled in the art will further appreciate that the invention is equally applicable for the detection and conversion of other high frequency electromagnetic energy. The invention will be described with respect to a “third generation” CT scanner, but is equally applicable with other CT systems.

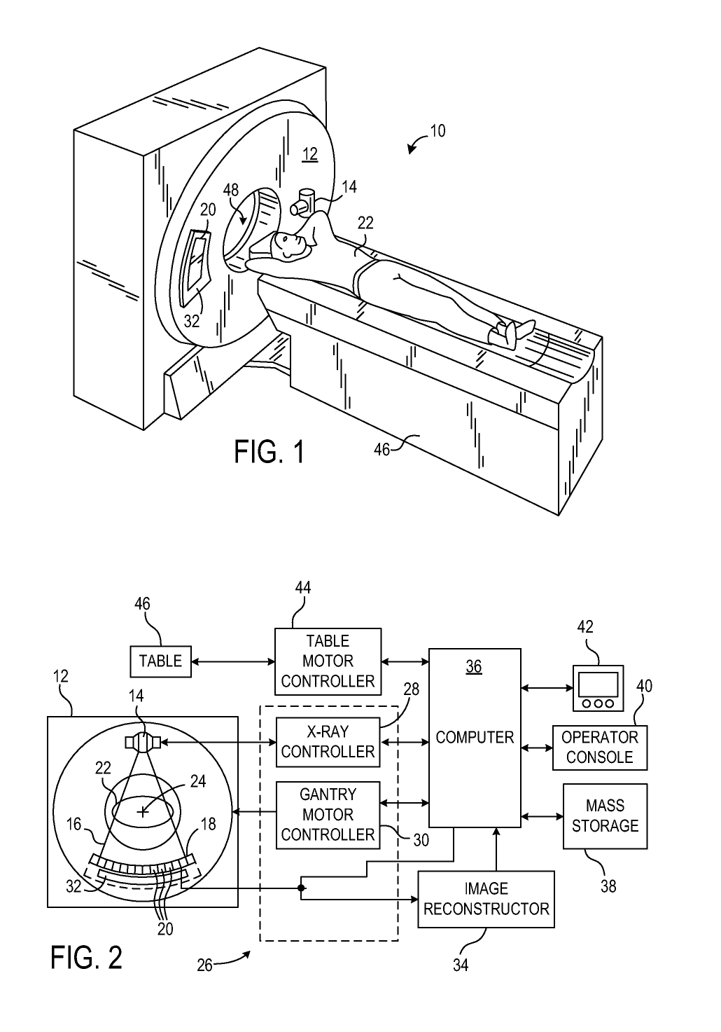

Referring to FIG. 1, a computed tomography (CT) imaging system 10 is shown as including a gantry 12 representative of a “third generation” CT scanner. Gantry 12 has an x-ray source 14 that projects a beam of x-rays toward a detector assembly or collimator 18 on the opposite side of the gantry 12. Referring now to FIG. 2, detector assembly 18 is formed by a plurality of detectors 20 and data acquisition systems (DAS) 32. The plurality of detectors 20 sense the projected x-rays 16 that pass through a medical patient 22, and DAS 32 converts the data to digital signals for subsequent processing. Each detector 20 produces an analog electrical signal that represents the intensity of an impinging x-ray beam and hence the attenuated beam as it passes through the patient 22. During a scan to acquire x-ray projection data, gantry 12 and the components mounted thereon rotate about a center of rotation 24.

Rotation of gantry 12 and the operation of x-ray source 14 are governed by a control mechanism 26 of CT system 10. Control mechanism 26 includes an x-ray controller 28 that provides power and timing signals to an x-ray source 14 and a gantry motor controller 30 that controls the rotational speed and position of gantry 12. An image reconstructor 34 receives sampled and digitized x-ray data from DAS 32 and performs high speed reconstruction. The reconstructed image is applied as an input to a computer 36 which stores the image in a mass storage device 38, such as a PACS.

Computer 36 also receives commands and scanning parameters from an operator via console 40 that has some form of operator interface, such as a keyboard, mouse, voice activated controller, or any other suitable input apparatus. An associated display 42 allows the operator to observe the reconstructed image and other data from computer 36. The operator supplied commands and parameters are used by computer 36 to provide control signals and information to DAS 32, x-ray controller 28 and gantry motor controller 30. In addition, computer 36 operates a table motor controller 44 which controls a motorized table 46 to position patient 22 and gantry 12. Particularly, table 46 moves patient 22 through a gantry opening 48 of FIG. 1 in whole or in part.

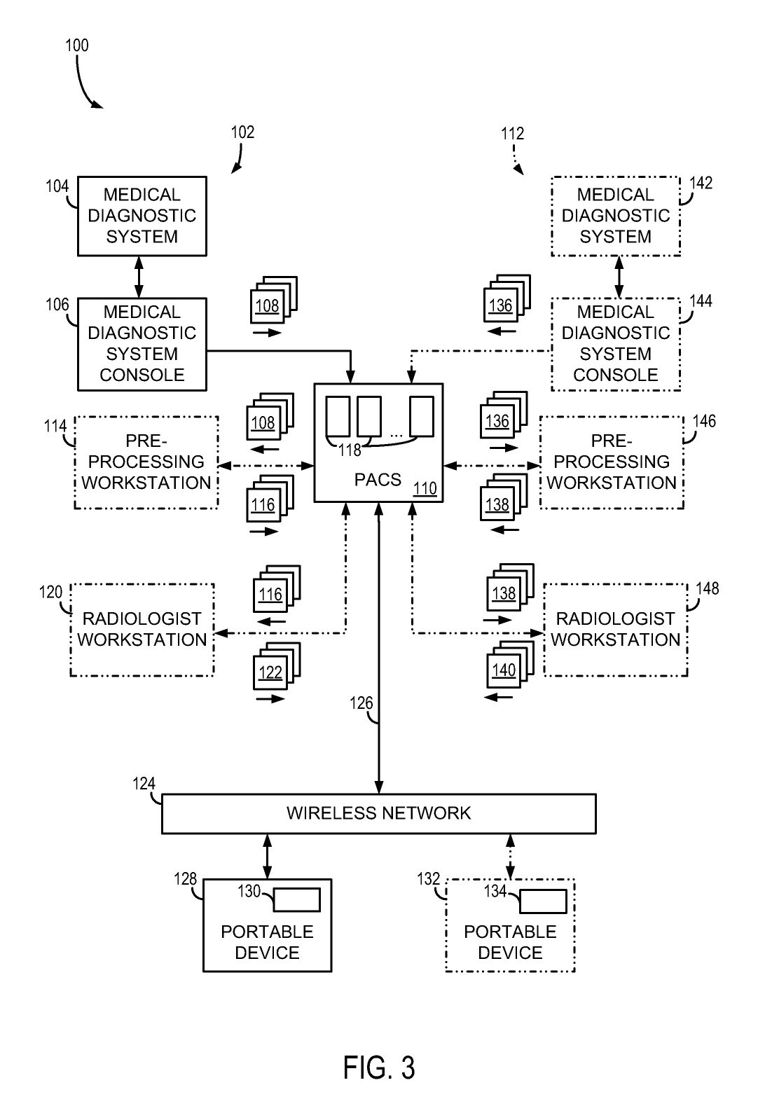

Referring now to FIG. 3, an image processing and analysis system 100 is illustrated as including a networked system of imaging devices 102 for generating diagnostic images of a patient, such as patient 22 of FIGS. 1 and 2. System 102 includes a medical diagnostic system 104. In one embodiment medical diagnostic system 104 is a CT system, such as CT imaging system 10 illustrated in FIGS. 1 and 2. However, as stated, medical diagnostic system 104 is not limited to a CT system and may be any imaging system that obtains imaging data of an object, is controlled and accessed from a computer terminal, and may be accessed via a remote device. In general, medical diagnostic system 104 will operate under the control of one or more clinicians, technicians, or radiologists who acquire image data by interaction at a medical diagnostic system console 106. In one embodiment, medical diagnostic system console 106 is an operator console such as console 40 illustrated in FIG. 2.

Console 106 may include, as examples, a monitor for displaying imaging information, patient information, scanning protocol information, and the like. Console 106 may also include a keyboard and/or mouse for accessing a computer, such as computer 36 of imaging system 10 (FIG. 2). According to various embodiments, console 106 may be wholly or partially integrated with medical diagnostic system 104 and may partially process raw data or produce viewable images for the operator. It is contemplated that numerous tasks may be performed on medical diagnostic system 104 using medical diagnostic system console 106. For instance, tasks that may be performed include but are not limited to processing imaging data, viewing imaging data, displaying a patient list, displaying next patient information, editing patient data, displaying non-imaging medical information of the patient, displaying a procedure to be performed, displaying an indication that a next patient is ready for imaging, displaying a procedure to be performed, administering x-rays, and monitoring a state of the imaging system. Console 106 may also reconstruct image data based upon the specifications of the particular modality of the medical diagnostic system 104. Such reconstruction may allow the operator at console 106 to save, pre-process, discard, or otherwise manage the images and image data acquired.

Image data files resulting from imaging sequences at medical diagnostic system 104, designated generally by reference numeral 108, will be stored by the operator interacting with console 106 at a shared memory device 110, such as PACS 38 illustrated in FIG. 2. PACS 110 receives medical image data from medical diagnostic system 104 and is used for long-term storage of medical image data. In the illustrated embodiment, PACS 110 may be configured to receive image data from medical diagnostic system 104 as well as any number of other separate imaging systems such as optional second networked system of imaging devices 112 (shown in phantom). The PACS 110 may include a number of individual storage devices that are networked to one another for management of image data files 108.

As will be appreciated by those skilled in the art, the imaging systems 102, 112 may be of various types and modalities, such as MRI systems, PET systems, radio fluoroscopy (RF), computed radiography (CR), ultrasound systems, digital X-ray systems, X-ray tomosynthesis systems, and so forth. Imaging systems 102, 112 may be located locally with respect to PACS 110, such as in the same institution or facility, or may be entirely removed from PACS 110, such as in an outlying clinic or affiliated institution. In the latter case, the image data may be transmitted via any suitable network link, including open networks, proprietary networks, virtual private networks, and so forth.

In the illustrated embodiment, PACS 110 stores image files 108, which may be at various stages of processing, as described below. In general, these files 108 may be stored in accordance with convenient formats, typically conforming to standards known in the field as DICOM standards. Image files 108 will be typically stored and associated with one another such that images saved from an examination of a patient in a particular session will be associated with one another for pre-processing, processing, and reading by radiologists. The images may also be associated in such a way to permit two-dimensional (2D), three-dimensional (3D), or four-dimensional (4D) reconstruction, processing, and viewing.

In general, the images that can be reconstructed from image data files 108 will include images that are sufficiently complex to require pre-processing or require sequential steps in processing. Presently contemplated image data, for example, may include multi-dimensional image data, such as 3D data, or image data that can be rendered in three dimensions. Other 2D and 4D data may also be accommodated by the techniques disclosed herein.

Image processing and analysis system 100 may also include a number of digital tools used to store, pre-process, and facilitate management of image data files 108. As one example, system 100 may include an optional pre-processing workstation 114 (shown in phantom) for pre-processing image data files 108 retrieved from PACS 110. According to various embodiments, pre-processing workstation 114 is configured to allow an operator to perform a wide range of image pre-processing, processing, enhancement, and analysis. In general, such pre-processing may be performed to allow an operator to select images from a series of images for consideration by a radiologist, select regions of interest in such images, process such images and regions of interest, highlight or otherwise annotate the images, filter or alter renderings of images, perform analysis in three and four dimensions, and so forth. Pre-processed image files 116 are stored on PACS 110.

In one embodiment, PACS 110 includes one or more file servers 118 designed to receive and process image data and to make the image data available for decompression and review. Alternatively, or in addition thereto, image processing and analysis system 100 may include an optional radiologist workstation 120 (shown in phantom) to enable a radiologist to access pre-processed image files 116, to further analyze the images, and to finally process the images such as by the addition of annotations, highlights, textual and auditory analyses, and so forth. Processed image files 122 are stored on PACS 110.

PACS 110 is coupled to wireless network 124 via a wireless connection 126. In a preferred embodiment, wireless network 124 is a third-generation (3G) network. A remote personal or portable device 128 includes a processor 130 and may be used to access image data stored on medical diagnostic system 104 or PACS 110 by one user via wireless network 124 wirelessly and remotely, while another user is simultaneously accessing medical diagnostic system 104 using medical diagnostic system console 106. Tasks that may be performed using portable device 128 include but are not limited to receiving processed imaging data, viewing imaging data, manipulating imaging data, displaying a patient list, displaying patient information, editing patient data, and displaying non-imaging medical information of the patient.

In embodiments of the invention, portable device 128 is one of a tablet PC, a smart phone, a portable media player, and a purpose-built device (i.e., a remote device fabricated explicitly for the purpose of wirelessly and remotely accessing medical diagnostic system 104). One skilled in the art will recognize that portable device 128 may be any device that may be wirelessly coupled to another device and is not limited to the listed device types.

As stated, medical diagnostic system 104 may include a computer such as computer 36 of system 10 illustrated in FIGS. 1 and 2. Thus, additional software features may be incorporated in medical diagnostic system 104 to include, for instance, an encryption/decryption ability between medical diagnostic system console 106, PACS 110, and portable device 128. In such fashion, data may be prevented from being intercepted or understood from an undesirable additional wireless receiver in order to protect patient privacy.

According to embodiments of the invention, multiple approved portable devices may be used to access image data generated by medical diagnostic system 102. That is, portable device 128 may be used to access system 102, and another optional portable device 132 (shown in phantom) having a processor 134 may also be used to simultaneously access system 102 as well. As with portable device 128, portable device 132 may include any device type as described, and functionality may be limited as well. Further, portable devices 128 and 132 may be different from one another (that is, one may be a tablet PC while another may be a smart phone, as one example).

It is contemplated that image data generated by multiple networked systems of imaging devices may be accessed remotely by portable devices 128, 132 as well. Referring still to FIG. 3, portable devices 128, 132 may be used to access image data files in various states of processing (e.g., image data files 108, pre-processed image files 116, processed image files 122) generated by first networked system of imaging devices 102 and image data files (e.g., image data files 136, pre-processed image files 138, processed image files 140) generated by second networked system of imaging devices 112 (shown in phantom). As illustrated, second networked system 112 includes a respective medical diagnostic system 142, medical diagnostic system console 144, optional pre-processing workstation 146, and optional radiologist workstation 148, similar to like-named elements of networked system 102.

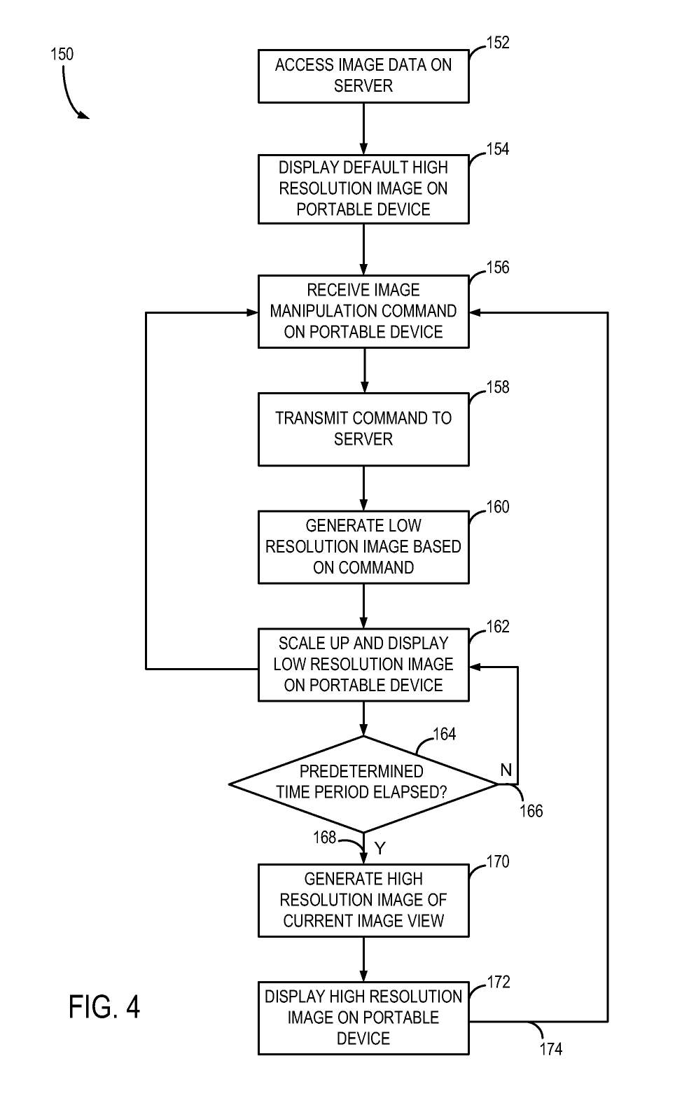

Referring now to FIG. 4, a technique 150 is set forth for wirelessly accessing, viewing, and interacting with medical image data via a remote device, such as portable device 128 of FIG. 3. As described in detail below, technique 150 may be used to access raw, pre-processed, or processed image data from a mass storage device, such as PACS 110 (FIG. 3); display a high resolution image corresponding to the image data on a portable device, such as portable device 128 (FIG. 3); update the image displayed on the portable device in real time with a low resolution image based on user interaction with the image; and display a high resolution image on the personal device following a period of user inactivity.

Technique 150 begins at step 152 through the use of a portable device, such as portable device 128 (FIG. 3), to access image data stored on a server, such as file server 118 of PACS 110 or medical diagnostic system console 106 of FIG. 3. In particular, the portable device receives a user input image data corresponding to image data of interest and transmits the request via a wireless network, such as wireless network 124 (FIG. 3), to the server. The user input may be a request to access image data corresponding to a medical image for a patient of interest or to access a particular series of images for a patient of interest, as examples.

In one embodiment, a user accesses the image data through a webpage that is programmed to allow restricted access to a medical environment. For example, the webpage may receive a user name and password and allow access to a virtual private network (VPN) within the hospital. In such an embodiment, a processor embodied in a computing device external to the personal device, such as, for example, a computer workstation or a file server, facilitates transmission of commands and image data to and from the personal device. In alternative embodiments, a user may access the image data through a processor embedded within the personal device using an application that is downloaded onto the personal device and programmed to wirelessly communicate with a hospital server to transmit image data stored on a PACS or imaging workstation. Such applications may include, as examples, programs for cellular phone or tablet PC-based operating systems such as .ipa files or .apk files.

At step 154, technique 150 loads image data corresponding to the user input off of the PACS or imaging workstation and into memory on the server. The server uses the image data to render a static, default view of a high resolution image (e.g., approximately 500×500 pixels) suitable for displaying on the personal device. The default high resolution image is compressed and transmitted to the portable device via the wireless network. Upon receipt, the portable device decompresses the default high resolution image and displays the image on the portable device.

At step 156, the user interacts with the image on the personal device using a touch screen or keypad on the personal device to manipulate the image view. The user interaction may include, as examples, zooming in or out on a particular region of interest in the image, changing view parameters, altering the view angle, changing image contrast or brightness, and the like. A command corresponding to the user interaction with the image is transmitted to the server at step 158 via the wireless network. At step 160, the server interprets the relayed user command and renders a transient or low resolution image from the image data based on the user command. In one embodiment, the transient image has an image resolution of approximately 100×100 pixels or voxels, for example. As one example, server may generate a low resolution image at a different view angle than the original high resolution image responsive to a user command to change the view angle.

At step 162, the transient or low resolution image is compressed and transmitted via the wireless network from the server to the portable device. Upon receipt by the portable device, the compressed low resolution image is decompressed and displayed to the user thereon. Because of its lower resolution (and therefore smaller file size) than the static, high resolution image displayed at step 154, the transient image is uploaded over the wireless network and displayed on the personal device in near real time with the user interaction with the image. However, because the image is displayed at a lower resolution than the resolution of the display window of the portable device, the low resolution image is scaled up to the size of the portable device's image display window by increasing the size of pixels of the image to “stretch” the image to fit the dimensions (i.e., the height and/or width) of the display window. While the up-scaling of the low resolution image may cause the image to appear blurry or out of focus when displayed on the personal device, the displayed image has an acceptable amount of clarity to allow the user to continue to interact with the image and uploads to the personal device over the wireless network at a significantly faster rate than would be achieved through the wireless transfer of higher resolution images such as the high resolution image obtained at step 154.

Technique 150 repeats the steps set forth with respect to steps 156-162 during an image interaction period as additional image manipulation commands are received on the portable device from the user during an image manipulation period. For example, when a second image manipulation command is received on the portable device at step 156, the second image manipulation command is wirelessly transmitted to the server at step 158, a low resolution image is generated based on the second image manipulation command at step 160, and the low resolution image corresponding to the second image manipulation command is scaled up to the size of the display of the portable device and displayed on the portable device at step 162. In effect, the server re-renders the previous low-resolution image or transient image responsive to each subsequent image manipulation command.

At step 162, technique 150 determines whether a predetermined time period has elapsed 164 since the most recent image manipulation command was received on the portable device at step 156. According to various embodiments, the predetermined time period may be selected based on a given amount of time that would indicate that the user has paused or stopped interacting with the image. If the most recent image manipulation command was received prior to the expiration of the predetermined time period 166, technique 150 cycles back to step 162 and continues to display the low resolution image corresponding to the most recent image manipulation command.

On the other hand, if at step 164 technique 150 determines that the predetermined time period has elapsed 168, a request is sent to the server to generate a high resolution image corresponding to the current low resolution image displayed on the personal device at step 170 (i.e., corresponding to the most recent image manipulation commanded received at step 156). In one embodiment, the server generates an image having a similar resolution as the high resolution image initially displayed on the personal device at step 154, and may have, as an example, a resolution of approximately 500×500 pixels or voxels. At step 172, the high resolution is transmitted from the server via the wireless network and displayed on the portable device.

If the user continues to interact with the image on the personal device subsequent to step 172, technique 150 follows path 174 during the user interaction period and repeats the sequence of steps 156 through 172, as described above.

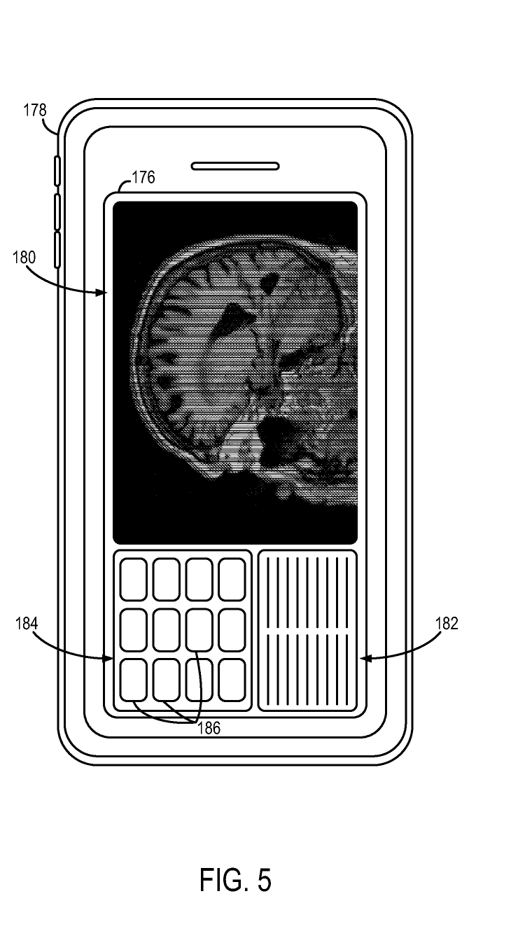

According to various embodiments, the images displayed on the portable device at steps 154, 162, and 172 of technique 150 may be displayed on a graphical user interface (GUI) 176 as illustrated in FIG. 5. GUI 176 is shown in FIG. 5 in an embodiment wherein the portable device is a smartphone 178. However, one skilled in the art will readily recognize that GUI 176 is equality applicable to alternative types of portable devices, such as a tablet or other personal computing device, as described above with respect to FIG. 3. Further, a skilled artisan will recognize that GUI 176 is equally applicable to embodiments wherein the user accesses the image data through a webpage or using an application for a smartphone or tablet.

GUI 176 includes a region 180 for displaying medical images, such as images displayed on the portable device at steps 154, 162, and 172 of technique 150. GUI 176 also includes one or more data regions 182 to display numeric and textual data including, for example, patient-specific data, image data, and the like. A user input region 184 includes a number of various image manipulation buttons 186 to allow the user to interact with the image. For example, region 184 may include buttons for zooming in and out, rotating an image view, changing image contrast or brightness, selecting a region of interest, and the like. Optionally, one or more of regions 182, 184 may be configured as a control panel to permit a user to input and/or select data through input fields, dropdown menus, etc. It is noted that the arrangement of GUI 176 is provided merely for explanatory purposes and that other GUI arrangements are within the scope of various embodiments of the invention.

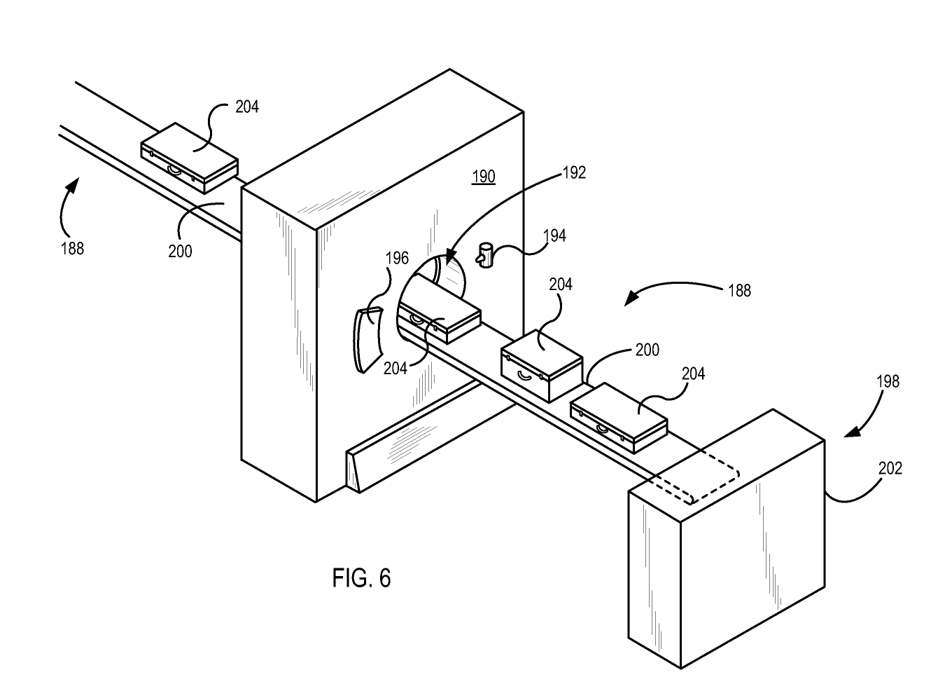

Referring now to FIG. 6, package/baggage inspection system 188 includes a rotatable gantry 190 having an opening 192 therein through which packages or pieces of baggage may pass. The rotatable gantry 190 houses a high frequency electromagnetic energy source 194 as well as a detector assembly 196 having scintillator arrays comprised of scintillator cells. A conveyor system 198 is also provided and includes a conveyor belt 200 supported by structure 202 to automatically and continuously pass packages or baggage pieces 204 through opening 192 to be scanned. Objects 204 are fed through opening 192 by conveyor belt 200, imaging data is then acquired, and the conveyor belt 200 removes the packages 204 from opening 192 in a controlled and continuous manner. As a result, postal inspectors, baggage handlers, and other security personnel may non-invasively inspect the contents of packages 204 for explosives, knives, guns, contraband, etc.

In sum, embodiments of the invention set forth herein permit user interaction with image data on a personal device over a wireless network while displaying image views that are rapidly updated in real time on the personal device. Because the images displayed during the period of time wherein the user is interacting with the data are low resolution images that are scaled up to match the size of the display on the personal device rather than the typical high resolution images transmitted from the server, a slow connection speed or download time does not significantly impact the user's ability to visualize real time changes in the image based on the user interaction. During periods of inactivity, after the user pauses or stops interacting with the image data, the server transmits a high resolution image corresponding to the most recent user interaction, which is displayed on the personal device.

A technical contribution for the disclosed method and apparatus is that it provides for a computer implemented system and method for wireless interaction with medical image data.

One skilled in the art will appreciate that embodiments of the invention may be interfaced to and controlled by a computer readable storage medium having stored thereon a computer program. The computer readable storage medium includes a plurality of components such as one or more of electronic components, hardware components, and/or computer software components. These components may include one or more computer readable storage media that generally stores instructions such as software, firmware and/or assembly language for performing one or more portions of one or more implementations or embodiments of a sequence. These computer readable storage media are generally non-transitory and/or tangible. Examples of such a computer readable storage medium include a recordable data storage medium of a computer and/or storage device. The computer readable storage media may employ, for example, one or more of a magnetic, electrical, optical, biological, and/or atomic data storage medium. Further, such media may take the form of, for example, floppy disks, magnetic tapes, CD-ROMs, DVD-ROMs, hard disk drives, and/or electronic memory. Other forms of non-transitory and/or tangible computer readable storage media not list may be employed with embodiments of the invention.

A number of such components can be combined or divided in an implementation of a system. Further, such components may include a set and/or series of computer instructions written in or implemented with any of a number of programming languages, as will be appreciated by those skilled in the art. In addition, other forms of computer readable media such as a carrier wave may be employed to embody a computer data signal representing a sequence of instructions that when executed by one or more computers causes the one or more computers to perform one or more portions of one or more implementations or embodiments of a sequence.

According to an embodiment of the invention, a non-transitory computer readable storage medium has stored thereon a computer program comprising instructions which, when executed by a computer, cause the computer to transmit a request over a wireless network for a first medical image from a server coupled to a medical image database, the first medical image having a first image resolution. The instructions also cause the computer to display the first medical image on a GUI of a wireless personal device, receive a user-selected command to modify the first medical image, and transmit a request over the wireless network to the server to generate a transient image responsive to the command to modify. The transient image has a second image resolution that is lower than the first image resolution. Further, the instructions cause the computer to display the transient image on the GUI and compare a period of user inactivity with a threshold. If the period of user inactivity is greater than the threshold, the instructions cause the computer to transmit a request over the wireless network to the server to generate a second medical image from the server, the second medical image corresponding to the transient image and having the first image resolution and display the second medical image on the GUI.

According to another embodiment of the invention, a method of transmitting medical image data includes accessing image data obtained by a medical imaging system via a server coupled to the medical imaging system, transmitting a first static image from the server via a wireless network to a personal device, and displaying the first static image on the personal device. The method also includes receiving a command on the server from the personal device to update the first static image based on a user input and transmitting a transient image from the server to the personal device via the wireless network responsive to the command, the transient image having an image resolution lower than an image resolution of the first static image. Further, the method includes displaying the transient image on the personal device, identifying a period of user inactivity on the personal device, and transmitting a second static image from the server to the personal device via the wireless network following the period of user inactivity. The second static image corresponds to the transient image and has an image resolution greater than the image resolution of the transient image. Still further, the method includes displaying the second static image on the personal device.

According to yet another embodiment of the invention, an imaging system includes a remote device coupled to a server via a wireless network. The remote device is configured to communicate with the server to request and receive images over the wireless network. The imaging system also includes a processor that is programmed to request a first image from the server via the wireless network, the first image having a first image resolution, display the first image on a GUI of the remote device, and receive an image manipulation command from a user. The processor is also programmed to request an updated image from the server via the wireless network based on the image manipulation command and display the updated image on the GUI, the updated image having a second image resolution that is lower than the first image resolution. Further, if a predetermined time period has elapsed following receipt of the image manipulation command, the processor is programmed to request a high resolution updated image from the server corresponding to the updated image, the high resolution updated image having the first image resolution, and display the high resolution updated image on the GUI.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A non-transitory computer readable storage medium having stored thereon a computer program comprising instructions which, when executed by a computer, cause the computer to:
transmit a request over a wireless network for a first medical image from a server coupled to a medical image database, the first medical image having a first image resolution;
display the first medical image on a graphical user interface (GUI) of a wireless personal device;
receive a user-selected command to modify the first medical image;
transmit a request over the wireless network to the server to generate a transient image responsive to the command to modify, the transient image having a second image resolution that is lower than the first image resolution;
display the transient image on the GUI;
compare a period of user inactivity with a threshold; and
if the period of user inactivity is greater than the threshold:
transmit a request over the wireless network to the server to generate a second medical image from the server, the second medical image corresponding to the transient image and having the first image resolution; and
display the second medical image on the GUI.

2. The computer readable storage medium of claim 1 wherein the instructions further cause the computer to scale up the transient image to match at least one of the height and width of an image viewing region of the GUI.

3. The computer readable storage medium of claim 1 wherein the instructions further cause the computer to display the transient image in near real time with respect to receipt of the command to modify the first medical image.

4. The computer readable storage medium of claim 1 wherein the instructions further cause the computer to identify the period of user inactivity based on a difference between a current time and a time of receipt of the command to modify the first medical image.

5. The computer readable storage medium of claim 1 wherein the instructions further cause the computer to:
receive a user-selected command to modify the transient image;
transmit a request over the wireless network to the server to generate a modified transient image responsive to the command to modify the transient image; and
display the modified transient image on the GUI.

6. The computer readable storage medium of claim 5 wherein the instructions further cause the computer to display the modified transient image in near real time with respect to receipt of the command to modify the transient image.

7. The computer readable storage medium of claim 5 wherein the instructions further cause the computer to identify the period of user inactivity based on a difference between a current time and a time of receipt of the command to modify the transient image.

8. The computer readable storage medium of claim 7 wherein, if the period of user inactivity is identified, the instructions further cause the computer to:
transmit a request over the wireless network to the server to generate a third medical image, the third medical image corresponding to the modified transient image and having the first image resolution; and
display the third medical image on the GUI.

9. The computer readable storage medium of claim 1 wherein the instructions reside on the wireless personal device.

10. A method of transmitting medical image data comprising:
accessing image data obtained by a medical imaging system via a server coupled to the medical imaging system;
transmitting a first static image from the server via a wireless network to a personal device;
displaying the first static image on the personal device;
receiving a command on the server from the personal device to update the first static image based on a user input;
transmitting a transient image from the server to the personal device via the wireless network responsive to the command, the transient image having an image resolution lower than an image resolution of the first static image;
displaying the transient image on the personal device;
identifying a period of user inactivity on the personal device; and
transmitting a second static image from the server to the personal device via the wireless network following the period of user inactivity, the second static image corresponding to the transient image and having an image resolution greater than the image resolution of the transient image; and
displaying the second static image on the personal device.

11. The method of claim 10 further comprising:
receiving one or more commands on the server from the personal device to re-render the transient image during an image manipulation period, wherein the image manipulation period comprises a time period wherein two consecutive commands of the one or more commands are received on the server within a predetermined time period; and
transmitting a re-rendered transient image from the server to the personal device via the wireless network responsive to each received command, wherein each re-rendered transient image has an image resolution approximately equal to the image resolution of the transient image.

12. The method of claim 11 further comprising displaying each re-rendered transient image on the personal device in near real time responsive to receipt of the one or more commands.

13. The method of claim 10 further comprising scaling the transient image up to match at least one dimension of a view window of the personal device.

14. The method of claim 10 further comprising identifying the period of user inactivity if a time period between receipt of the command to update the static image and receipt of a command to update the transient image exceeds a predetermined time period.

15. The method of claim 10 further comprising transmitting the command to the server from the personal device to update the first static image, wherein transmitting the command comprises transmitting a command to the server to render the transient image.

16. An imaging system comprising:
a remote device coupled to a server via a wireless network, the remote device configured to communicate with the server to request and receive images over the wireless network; and
a processor programmed to:
request a first image from the server via the wireless network, the first image having a first image resolution;
display the first image on a graphical user interface (GUI) of the remote device;
receive an image manipulation command from a user;
request an updated image from the server via the wireless network based on the image manipulation command;
display the updated image on the GUI, the updated image having a second image resolution that is lower than the first image resolution; and
if a predetermined time period has elapsed following receipt of the image manipulation command:
request a high resolution updated image from the server corresponding to the updated image, the high resolution updated image having the first image resolution; and
display the high resolution updated image on the GUI.

17. The imaging system of claim 16 wherein the remote device comprises one of a smart phone and a tablet personal computer.

18. The imaging system of claim 16 wherein the processor is embodied within the remote device.

19. The imaging system of claim 16 wherein the processor is embodied in a computing device external to the remote device, the computing device comprising one of a computer workstation and a file server.

20. The imaging system of claim 16 wherein the wireless network comprises a wireless third-generation network.
